(19) United States
(12) Patent Application Publication
(10) Pub. No.: US 2011/0268065 A1
(43) Pub. Date: Nov. 3, 2011

(54) APPARATUS AND METHOD FOR IMPROVING TRANSMISSION EFFICIENCY IN WIRELESS COMMUNICATION SYSTEM

(75) Inventors: Hye-Mi Park, Yongin-si (KR); Jae-Ho Jeon, Seongnam-si (KR); Byung-Chan Ahn, Seoul (KR); Nam-Koo Kang, Suwon-si (KR)

(73) Assignee: SAMSUNG ELECTRONICS CO., LTD., Suwon-si (KR)

(21) Appl. No.: 13/100,176

(22) Filed: May 3, 2011

(30) Foreign Application Priority Data
May 3, 2010 (KR) 10-2010-0041379

(51) Int. Cl. H04W 72/04

(52) U.S. Cl. 370/329

(57) ABSTRACT

An apparatus and a method for scheduling resources in a wireless communication system are provided. A Modulation and Coding Scheme (MCS) level of resource allocation information of one or more terminals is determined. A temporary MCS level for resource allocation information of a frame is determined by considering an MCS level for resource allocation information of a k-th terminal of the set of terminals. A resource amount for allocating data is determined by considering the temporary MCS level. Whether a resource is allocable to the k-th terminal is determined by considering the resource amount for the data allocation. And when the resource is allocable to the k-th terminal, the MCS level of the resource allocation information of the frame is determined by considering the MCS level of the resource allocation information of the k-th terminal.

### CROSS-REFERENCE TO RELATED APPLICATION(S) AND CLAIM OF PRIORITY

The present application is related to and claims priority under 35 U.S.C. §119(a) to a Korean patent application filed in the Korean Intellectual Property Office on May 3, 2010 and assigned Serial No. 10-2010-0041379, the entire disclosure of which is hereby incorporated by reference.

### TECHNICAL FIELD OF THE INVENTION

The present invention relates generally to an apparatus and a method for improving transmission efficiency in a wireless communication system. More particularly, the present invention relates to an apparatus and a method for improving transmission efficiency of downlink data in the wireless communication system.

### BACKGROUND OF THE INVENTION

Fourth Generation (4G) communication systems ensure mobility and various Quality of Service (QoS) levels and support high-speed services in Broadband Wireless Access (BWA) communication systems. A representative 4G communication system is the Institute of Electrical and Electronics Engineers (IEEE) 802.16 communication system. For broadband transmission, the IEEE 802.16 communication system adopts Orthogonal Frequency Division Multiplexing (OFDM)/Orthogonal Frequency Division Multiple Access (OFDMA) scheme.

The OFDM/OFDMA communication system constitutes a subchannel with orthogonal subcarriers. The communication system transmits data on a frame basis. The communication system forms a slot by combining the subchannels over a particular symbol interval of one frame. Herein, the slot indicates a minimum resource unit in two dimensions including time and frequency.

The frame includes a downlink subframe and an uplink subframe. The downlink subframe includes resource allocation information including data burst allocation information of the uplink and the downlink. For example, the OFDM/OFDMA communication system includes a downlink MAP and an uplink MAP including the data burst allocation information.

As discussed above, the downlink subframe of the communication system includes the resource allocation information (e.g., the uplink/downlink MAP). That is, the downlink performance of the communication system is affected by the percentage of the resource allocation information in the downlink subframe. In this respect, what is needed is a technique for efficiently allocating the resource allocation information in the communication system.

### SUMMARY OF THE INVENTION

To address the above-discussed deficiencies of the prior art, it is a primary aspect of the present invention to provide an apparatus and a method for improving downlink data transmission efficiency in a wireless communication system.

Another aspect of the present invention is to provide an apparatus and a method for adaptively determining a Modulation and Coding Scheme (MCS) level of resource allocation information in a wireless communication system.

Yet another aspect of the present invention is to provide an apparatus and a method for adaptively determining an MCS level of resource allocation information by considering channel state information of a terminal allocated the resource in a wireless communication system.

Still another aspect of the present invention is to provide an apparatus and a method for adaptively determining an MCS level of resource allocation information by considering Channel Quality Indicator (CQI) of a terminal allocated the resource in a wireless communication system.

According to one, aspect of the present invention, a resource scheduling method in a wireless communication system is provided. A Modulation and Coding Scheme (MCS) level of resource allocation information is determined for each of a set of terminals. A temporary MCS level for resource allocation information of a frame is determined by considering an MCS level for resource allocation information of a k-th terminal of the one or more terminals. A resource amount for allocating data is determined by considering the temporary MCS level. Whether a resource is allocable to the k-th terminal is determined by considering the resource amount for the data allocation. And when the resource is allocable to the k-th terminal, the MCS level of the resource allocation information of the frame is determined by considering the MCS level of the resource allocation information of the k-th terminal, where k denotes an index of a scheduling priority.

According to another aspect of the present invention, a resource scheduling apparatus in a wireless communication system includes a transmitter, a receiver, a Modulation and Coding Scheme (MCS) determiner, and a scheduler. The transmitter transmits a signal. The receiver receives a signal. The MCS determiner determines an MCS level of resource allocation information of a terminal. And a scheduler determines a resource amount for allocating data by considering a temporary MCS level determined by considering an MCS level for resource allocation information of a k-th terminal of the one or more terminals, and determines the MCS level of the resource allocation information of the frame by considering the MCS level of the resource allocation information of the k-th terminal when the resource is allocable to the k-th terminal according to the resource amount for the data allocation, where k denotes an index of scheduling priority.

According to yet another aspect of the present invention, a wireless communication system for scheduling resources is provided. A base station receives channel state information from a set of terminals. The base station determines a Modulation and Coding Scheme (MCS) level for resource allocation information for the one or more terminals by considering corresponding channel state information. The base station determines a resource amount for allocating data by considering a temporary MCS level determined based on an MCS level for resource allocation information of a k-th terminal of the one or more terminals, and determines the MCS level for the resource allocation information of the frame by considering the MCS level of the resource allocation information of the k-th terminal when the resource is allocable to the k-th terminal according to the resource amount for the data allocation, where k denotes an index of a scheduling priority.

Other aspects, advantages, and salient features of the invention will become apparent to those skilled in the art from the following detailed description, which, taken in conjunction with the annexed drawings, discloses embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a process of a base station for determining an MCS level of a terminal according to an embodiment of the present invention;

FIG. 2 illustrates a process of the base station for scheduling by considering the MCS level of the terminal according to an embodiment of the present invention;

FIG. 3 illustrates a process of the base station for scheduling by considering the MCS level of the terminal according to an exemplary embodiment of the present invention;

FIG. 4 illustrates a two-step scheduling process of the base station by considering the MCS level of the terminal according to an embodiment of the present invention;

FIG. 5 illustrates a process of the base station for determining whether to perform a second scheduling according to an embodiment of the present invention;

FIG. 6 illustrates a process of the base station for the second scheduling by considering the MCS level of the terminal according to an embodiment of the present invention; and

FIG. 7 illustrates the base station according to an exemplary embodiment of the present invention.

Throughout the drawings, like reference numerals will be understood to refer to like parts, components and structures.

### DETAILED DESCRIPTION OF THE INVENTION

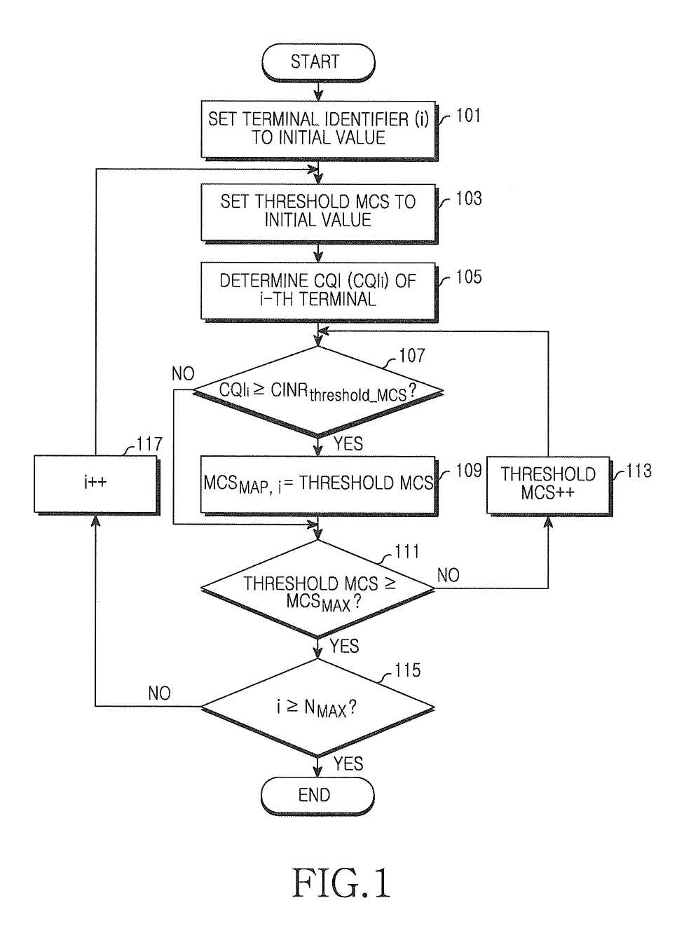

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Embodiments of the present invention will be described herein below with reference to the accompanying drawings. In the following description, well-known functions or constructions are not described in detail as they would obscure the invention in unnecessary detail. Terms described below, which are defined considering functions in the present invention, can be different depending on user and operator's intent or practice. Therefore, the terms should be defined on the basis of the disclosure throughout this specification.

Embodiments of the present invention provide a technique for adaptively determining an Modulation and Coding Scheme (MCS) level of resource allocation information by taking account of channel state information of a terminal allocated the resource in a wireless communication system.

Hereinafter, the resource allocation information is referred to as a MAP. The MAP includes a downlink MAP and an uplink MAP.

A base station of the wireless communication system determines the MCS level of the MAP for each terminal by considering the channel state information of the terminal as shown in FIG. 1.

FIG. 1 illustrates a process of the base station for determining the MCS level of the terminal according to an embodiment of the present invention.

In step 101, the base station sets a terminal identifier i to an initial value. For example, the base station sets the terminal identifier i to the initial value ‘1’.

In step 103, the base station sets a threshold MCS to an initial value. For example, the base station sets the initial value of the threshold MCS to the lowest MCS of MCSs provided by the base station.

In step 105, the base station determines channel state information CQIᵢ of the i-th terminal. For example, the base station determines Channel Quality Indicator (CQI) provided from the i-th terminal. Herein, the CQI indicates Carrier to Interference and Noise Ratio (CINR) measured by the i-th terminal using a preamble received from the base station.

In step 107, the base station compares the channel state information CQIᵢ of the i-th terminal with the CINR (CQI_{threshold}_{_{—}}_{MCS}) of the threshold MCS. For example, the base station includes threshold CINR information per MCS for obtaining stable performance according to the channel condition as shown in Table 1.

TABLE 1

| MCS | MCS_{MAP, mapping} | CINR_{threshold} | |
|---|---|---|---|
| 1 | QPSK 1/12 | −1.5 | dB |
| 2 | QPSK ⅛ | 1.2 | dB |
| 3 | QPSK ¼ | 5.1 | dB |
| 4 | QPSK ½ | above 5.1 | dB |

The threshold CINR per MCS can vary according to the channel condition and system environment as shown in Table 1.

When the channel state information of the i-th terminal is less than the CINR of the threshold MCS (CQIᵢ<CQI_{threshold}_{_{—}}_{MCS}), the base station determines whether the channel state information of the i-th terminal is compared with every MCS level in step 111. That is, the base station compares the threshold MCS with the maximum MCS (MCS_{MAX}).

When the channel state information of the i-th terminal is greater than or equal to the CINR of the threshold MCS (CQIᵢ≧CQI_{threshold}_{_{—}}_{MCS}), the base station sets the MCS level of the MAP for the i-th terminal to the threshold MCS (MCS_{MAP,i}=threshold MCS) in step 109.

In step 111, the base station determines whether the channel state information of the i-th terminal is compared with every MCS level. That is, the base station compares the threshold MCS with the maximum MCS (MCS_{MAX}).

When the threshold MCS is less than the maximum MCS MCS_{MAX} in step 111, the base station recognizes that the channel state information of the i-th terminal is not compared with every MCS level. Hence, the base station updates the threshold MCS in step 113. For example, the base station increases the threshold MCS by one (MCS++).

Next, the base station compares the channel state information CQIᵢ of the i-th terminal with the CINR (CQI_{threshold}_{_{—}}_{MCS}) of the threshold MCS in step 107. Herein, the threshold MCS indicates the threshold MCS updated in step 113.

When the threshold MCS is greater than or equal to the maximum MCS (MCS_{MAX}), the base station recognizes that the channel state information of the i-th terminal is compared with every MCS level. Hence, the base station determines whether the MCS level is determined for the MAP of every terminal to service in step 115. For doing so, the base station compares the terminal identifier i with the maximum number of terminals (N_{MAX}).

When the terminal identifier is less than the maximum number of the terminals, the base station recognizes that the MCS level of the MAP is not determined for every terminal to service. Thus, the base station updates a terminal index in step 117. For example, the base station increases the terminal index by one (i++).

In step 103, the base station sets the threshold MCS to the initial value. For example, the base station sets the initial value of the threshold MCS to the lowest MCS of the MCSs provided by the base station.

Meanwhile, when the terminal identifier is greater than or equal to the maximum number of the terminals, the base station recognizes that the MCS level is determined for the MAP of every terminal to service. Next, the base station ends this process.

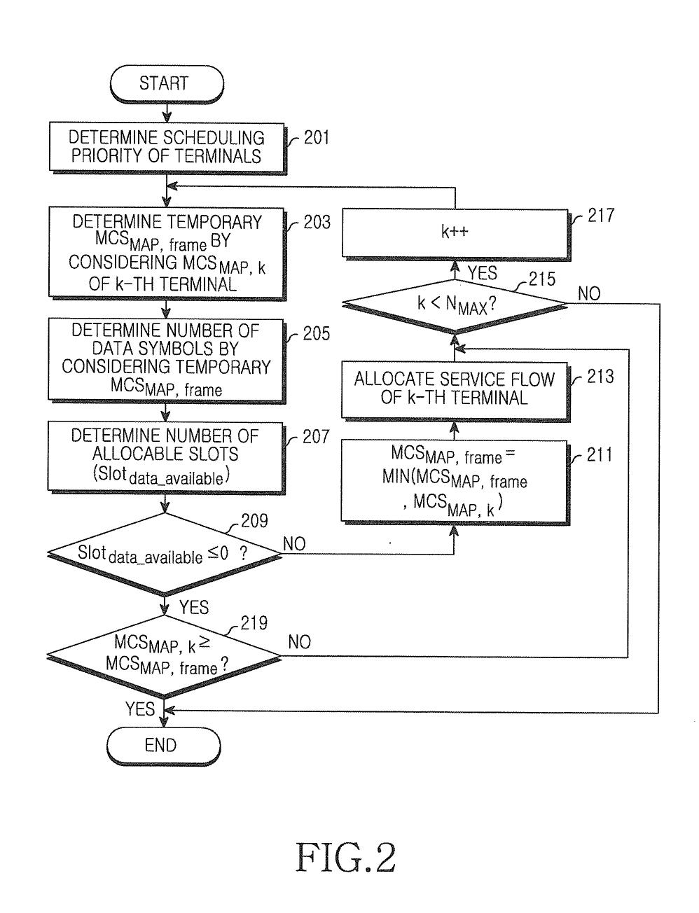

As stated above, the base station sets the MCS level for the MAP of each terminal by considering the channel condition of the terminal. Next, the base station schedules radio resource based on the MCS level of the terminals as shown in FIG. 2.

FIG. 2 illustrates a process of the base station for scheduling by considering the MCS level of the terminal according to an embodiment of the present invention. Hereafter, it is assumed that the base station determines the MCS level of the MAP for every terminal to service as shown in FIG. 1.

In step 201, the base station determines scheduling priority of the terminals to service. For instance, the base station determines the scheduling priority for the terminals for Proportional Fair (PF) scheduling.

In step 203, the base station determines a temporary MCS_{MAP,frame} by considering the MCS level MCS_{MAP,k} of the MAP for the k-th terminal. For example, the base station determines the temporary MCS_{MAP,frame} as the lower one of the MCS level MCS_{MAP,frame} of the MAP for the frame and the MCS level MCS_{MAP,k} of the MAP for the terminal, based on Equation 1. Herein, k, which is an index indicating the scheduling priority of the terminal, is ‘1’ as the initial value. ‘1’ is the highest scheduling priority order.

TempMCS_{MAP,Frame}=MIN(MCS_{MAP,Frame}, MCS_{MAP,k}) [Eqn. 1]

In Equation 1, TempMCS_{MAP,Frame} denotes the temporary MCS_{MAP,frame}, MCS_{MAP,k} denotes the MCS level of the MAP for the k-th terminal, and MCS_{MAP,Frame} denotes the MCS level of the MAP for the frame. Herein, MCS_{MAP,Frame} defines the greatest one of the MCS levels provided by the base station, as its initial value. For example, based on Table 1, the initial value of MCS_{MAP,Frame} is QPSK 1/2.

In step 205, the base station determines the number of data symbols of the corresponding frame based on the temporary MCS_{MAP,frame}. For example, based on the temporary MCS_{MAP,frame}, the base station calculates the number of the symbols to use for the MAP allocation. Next, the base station calculates the number of data symbols by removing the number of symbols to use for the MAP allocation from the total number of the symbols of the corresponding frame.

In step 207, the base station determines the number of available slots (Slot_{data}_{_{—}}_{available}) for allocating the data by considering the number of the data symbols. For example, the base station determines the number of the available slots for allocating the data based on Equation 2.

Slot_{data}_{_{—}}_{available}=Data_symbol×number of subchannel−slotₚᵣₑ [Eqn. 2]

In Equation 2, Slot_{data}_{_{—}}_{available} denotes the number of available slots for allocating the data, Data_symbol denotes the number of the data symbols calculated in step 205, number of subchannel denotes the number of subchannels, and Slotₚᵣₑ denotes the number of slots allocated to other terminal through the scheduling. The initial value of slotₚᵣₑ is zero (‘0’).

In step 209, the base station determines whether the resource can be allocated to the k-th terminal based on the number of the slots for allocating the data. That is, the base station determines whether a slot is allocable to the k-th terminal.

When the number of the slots is greater than zero (Slot_{data}_{_{—}}_{available}>0), the base station recognizes that the resource is allocable to the k-th terminal. Hence, the base station determines the MCS level of the MAP for the corresponding frame by considering the MCS level of the MAP for the k-th terminal in step 211. For example, the base station determines the lower MCS level of MCS_{MAP,Frame} and MCS_{MAP,k} as the MCS level of the MAP for the corresponding frame.

MCS_{MAP,Frame}=MIN(MCS_{MAP,Frame}, MCS_{MAP,k}) [Eqn. 3]

In Equation 3, MCS_{MAP,k} denotes the MCS level of the MAP for the k-th terminal and MCS_{MAP,Frame} denotes the MCS level of the MAP for the frame.

In step 213, the base station allocates a service flow to the k-th terminal by allocating to the k-th terminal at least one of the available slots to allocate the data.

In step 215, the base station determines whether the scheduling is carried out by considering all of the terminals. For doing so, the base station compares the scheduling priority index k with the maximum number of the terminals N_{MAX}.

When the scheduling priority index is less than the maximum number of terminals, the base station recognizes that not all of the terminals have been considered. Thus, the base station updates the scheduling priority index in step 217. For example, the base station increases the scheduling priority index by one (k++).

Next, the base station determines the temporary MCS_{MAP,frame} based on the MCS level MCS_{MAP,k} of the MAP for the k-th terminal in step 203. Herein, the k-th terminal indicates the terminal of the scheduling priority index updated in step 217.

When the scheduling priority index is greater than or equal to the maximum number of the terminals in step 215, the base station recognizes that the scheduling has considered all of the terminals. Accordingly, the base station ends this process.

When the number of the slots is less than or equal to zero (Slot_{data}_{_{—}}_{available}≦0) in step 209, the base station recognizes that the resource is not allocable to the k-th terminal. Thus, the base station determines whether to end the scheduling in step 219. For example, the base station determines whether to end the scheduling by comparing the MCS level of the MAP for the k-th terminal with the MCS level of the MAP for the frame.

When MCS_{MAP,k} is less than MCS_{MAP,Frame}, the base station recognizes that the resource is allocable to the terminal of the higher MCS level than MCS_{MAP,Frame}. Next, the base station determines whether the scheduling is carried out by considering all of the terminals in step 215. For doing so, the base station compares the scheduling priority index k with the maximum number of the terminals N_{MAX}.

In contrast, when MCS_{MAP,k} is greater than or equal to MCS_{MAP,Frame}, the base station recognizes that additional burst allocation is not feasible. Thus, the base station ends this process.

In this embodiment, the base station carries out the scheduling by considering the MCS level of the MAP for each terminal to service.

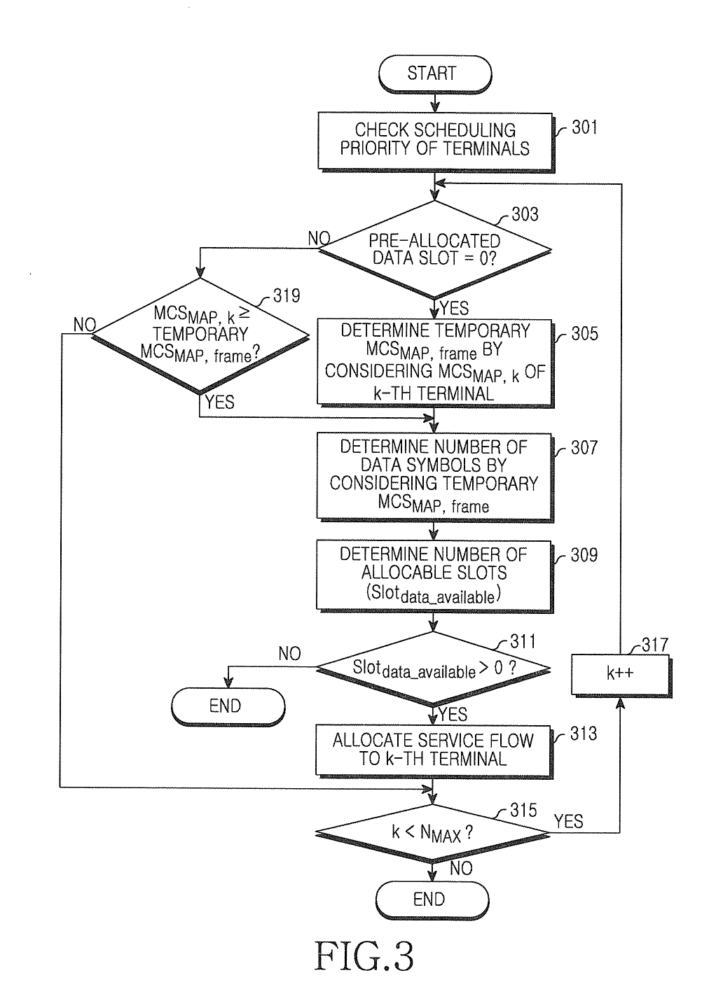

Alternatively, the base station may perform the scheduling by grouping the terminals based on the MCS level of the MAP as shown in FIG. 3.

FIG. 3 illustrates a process of the base station for scheduling by considering the MCS level of the terminal according to an embodiment of the present invention. Hereafter, it is assumed that the base station determines the MCS level of the MAP for every terminal to service as shown in FIG. 1.

In step 301, the base station determines the scheduling priority for the terminals to service. For example, the base station determines the scheduling priority for the terminals for PF scheduling.

In step 303, the base station determines whether there is the slot allocated for the burst. For doing so, the base station determines whether the number of the pre-allocated slots is zero (‘0’).

When the number of the pre-allocated slots is zero, the base station recognizes that there is no slot allocated for the burst. Hence, the base station determines the temporary MCS_{MAP,frame} by considering the MCS level MCS_{MAP,k} of the MAP for the k-th terminal in step 305. For example, the base station sets the MCS level MCS_{MAP,k} of the MAP for the k-th terminal to the temporary MCS_{MAP,frame}. Herein, k, which is the index indicating the scheduling priority of the terminal, is ‘1’ as the initial value. ‘1’ is the highest scheduling priority order.

In step 307, the base station determines the number of data symbols of the corresponding frame based on the temporary MCS_{MAP,frame}. For example, based on the temporary MCS_{MAP,frame}, the base station calculates the number of the symbols to use for the MAP allocation. Next, the base station calculates the number of data symbols by removing the number of symbols to use for the MAP allocation from the total number of the symbols of the corresponding frame.

In step 309, the base station determines the number of available slots Slot_{data}_{_{—}}_{available} for allocating the data by considering the number of the data symbols. For example, the base station determines the number of the slots for allocating the data based on Equation 2.

In step 311, the base station determines whether the resource can be allocated to the k-th terminal based on the number of the slots for allocating the data. That is, the base station determines whether the slot is allocable to the k-th terminal.

When the number of slots is less than or equal to zero (Slot_{data}_{_{—}}_{available}≦0), the base station recognizes that the resource is not allocable to the k-th terminal. Thus, the base station ends the scheduling process.

When the number of the slots is greater than zero (Slot_{data}_{_{—}}_{available}>0), the base station recognizes that the resource is allocable to the k-th terminal. Next, the base station allocates the service flow to the k-th terminal by allocating to the k-th terminal at least one of the available slots to allocate the data in step 313. When the k-th terminal is allocated the service flow for the first time, the base station sets the MCS level of the MAP for the k-th terminal to the MCS level of the MAP for the frame.

In step 315, the base station examines whether the scheduling has considered all of the terminals. For doing so, the base station compares the scheduling priority index k with the maximum number of the terminals N_{MAX}.

When the scheduling priority index is less than the maximum number of the terminals, the base station recognizes that not all of the terminals have been considered. Thus, the base station updates the scheduling priority index in step 317. For example, the base station increases the scheduling priority index by one (k++).

Next, the base station determines whether the slot is allocated for the burst in step 303.

In contrast, when the scheduling priority index is greater than or equal to the maximum number of terminals, the base station recognizes that all of the terminals have been considered in the scheduling. Accordingly, the base station ends this process.

When the number of the pre-allocated slots is greater than zero in step 303, the base station recognizes that the slot is allocated for the burst. Hence, the base station compares the temporary MCS_{MAP,frame} with the MCS level of the MAP for the k-th terminal in step 319. That is, the base station does not allocate the burst to the terminal of the lower MCS level than the MCS level of the MAP for the terminal to which the resource was first allocated through the scheduling. Accordingly, the base station compares the temporary MCS_{MAP,frame} with the MCS level of the MAP for the k-th terminal.

When the MCS level of the MAP for the k-th terminal is greater than or equal to the temporary MCS_{MAP,frame}, the base station recognizes that the resource is allocable to the k-th terminal. Next, the base station determines the number of the allocable data symbols of the corresponding frame based on the temporary MCS_{MAP,frame} in step 307. For example, based on the temporary MCS_{MAP,frame}, the base station calculates the number of the symbols to use for the MAP allocation. The number of the symbols used to allocate the MAP indicates the number of symbols to use to allocate the MAP up to the k-th terminal, based on the temporary MCS_{MAP,frame}.

Meanwhile, when the MCS level of the MAP for the k-th terminal is lower than the temporary MCS_{MAP,frame}, the base station recognizes that the resource is not allocated to the k-th terminal because the MCS level of the MAP for the k-th terminal is lower than the temporary MCS_{MAP,frame}. Thus, the base station determines whether the scheduling has considered all of the terminals in step 315. For doing so, the base station compares the scheduling priority index k with the maximum number of the terminals N_{MAX}.

As stated above, after determining the MCS level of the MAP for the frame, the base station excludes the terminal with the lower MCS level than the MCS level of the MAP from the scheduling. In so doing, when the base station allocates the resource during the PF scheduling, the terminal with the low MCS level of the MAP loses its scheduling opportunity during the current scheduling. Yet, because the terminal is not selected in the current scheduling and the priority of the terminal increases in the scheduling of the next frame, the probability of scheduling the terminal in the next frame rises.

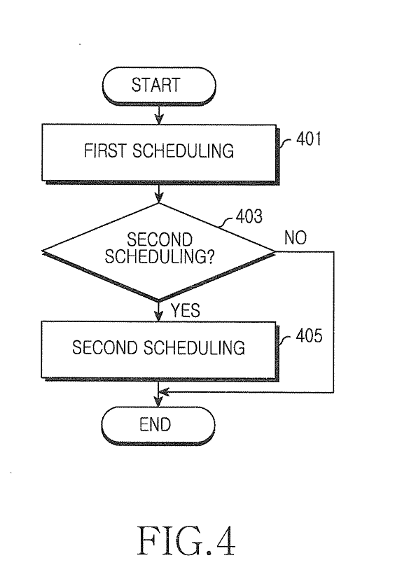

According to the MCS level of the MAP, the base station selectively schedules the terminal as shown in FIG. 3. Naturally, there can be a remaining slot that is unallocated to a terminal after the scheduling. Thus, the base station may additionally schedule the remaining resource as shown in FIG. 4.

FIG. 4 illustrates a two-step scheduling process of the base station by considering the MCS level of the terminal according to an embodiment of the present invention.

In step 401, the base station performs a first scheduling by considering the MCS level of the MAP for the terminals. For example, the base station carries out the first scheduling by considering only the terminals of the MCS level that is higher than or equal to the MCS level of the MAP for the frame as shown in FIG. 3.

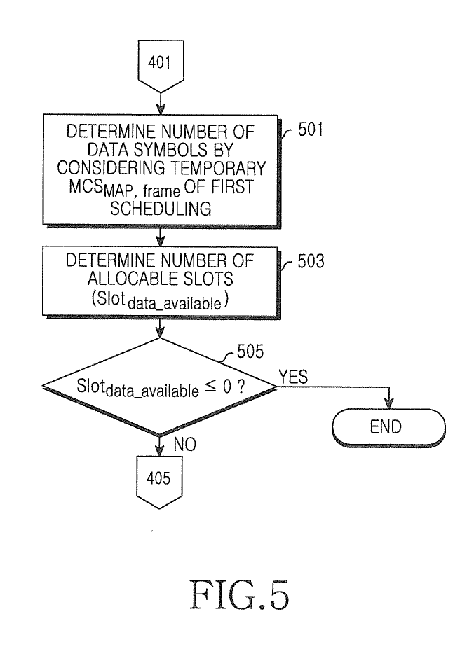

In step 403, the base station determines whether to perform a second scheduling. For example, the base station determines whether an unallocated slot remains after the allocation to the terminals through the first scheduling as shown in FIG. 5.

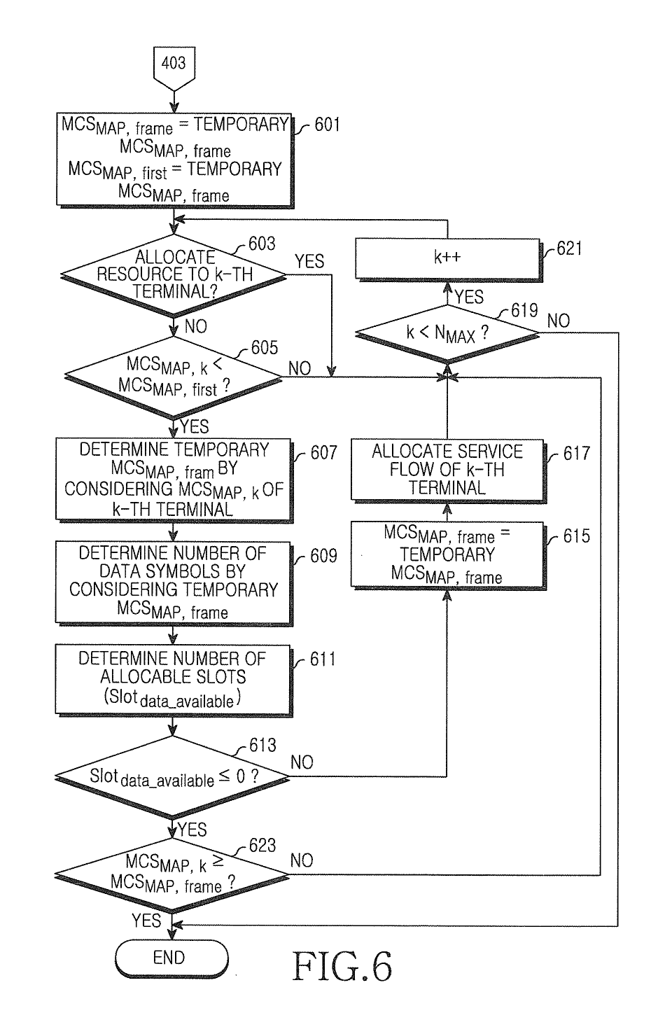

When a slot remains after the allocation to the terminals through the first scheduling, the base station recognizes the second scheduling is to be performed. Thus, the base station performs the second scheduling by considering the MCS level of the MAP for the terminals in step 405. For example, the base station executes the second scheduling as shown in FIG. 6.

When no slot remains after the allocation to the terminals through the first scheduling, the base station recognizes that the second scheduling is not to be performed. Next, the base station ends this process.

FIG. 5 illustrates a process of the base station for determining whether to perform a second scheduling step according to an embodiment of the present invention.

After the first scheduling in step 401 of FIG. 4, the base station determines the number of the data symbols of the corresponding frame by considering, the temporary MCS_{MAP,frame} of the first scheduling in step 501. For example, based on the temporary MCS_{MAP,frame}, the base station calculates the number of symbols to use to allocate the MAP of the terminals allocated the slots. Next, the base station calculates the number of data symbols by subtracting the number of symbols to use for the MAP allocation from the total number of the symbols of the corresponding frame.

In step 503, the base station determines the number of available slots Slot_{data}_{_{—}}_{available} for allocating the data by considering the number of data symbols. For example, the base station determines the number of allocable slots based on Equation 2.

In step 505, the base station determines whether to perform the second scheduling by considering the number of slots for allocating the data. That is, the base station determines whether an unallocated slot remains after the allocation to the terminals through the first scheduling.

When the number of slots available for data allocation is greater than zero, the base station recognizes that there remains at least one available slot after the allocation to the terminals through the first scheduling. Hence, the base station performs the second scheduling in step 405. For example, the base station carries out the second scheduling as shown in FIG. 6.

When the number of slots for data allocation is less than or equal to zero, the base station recognizes that there remains no slot after the allocation to the terminals through the first scheduling. Hence, the base station ends this process.

FIG. 6 illustrates the second scheduling step of the base station based on the MCS level of the terminal according to an embodiment of the present invention.

Upon determining to perform the second scheduling in step 403 of FIG. 4, the base station sets the MCS level MCS_{MAP,frame} of the MAP for the frame and the MCS level MCS_{MAP,first} of the MAP for the first terminal to the temporary MCS_{MAP,frame} in step 601.

In step 603, the base station determines whether the resource is allocated to the k-th terminal through the first scheduling. Herein, k, which denotes the index of the scheduling priority, has the initial value ‘1’. ‘1’ is the highest scheduling priority order.

When the resource is allocated to the k-th terminal through the first scheduling, the base station determines whether the scheduling has been conducted by considering all of the terminals in step 619. For doing so, the base station compares the scheduling priority index k with the maximum number of the terminals N_{MAX}.

When the resource is not allocated to the k-th terminal through the first scheduling, the base station determines whether the resource allocation to the k-th terminal has been attempted using the first scheduling in step 605. In other words, the first scheduling excludes the terminal of the MCS level that is lower than the temporary MCS_{MAP,frame} from the scheduling. Accordingly, to allocate the resources to the terminals excluded from the first scheduling in the second scheduling, the base station compares the MCS level MCS_{MAP,k} of the MAP for the k-th terminal with the MCS level of the MAP for the first terminal.

When the MCS level MCS_{MAP,k} of the MAP for the k-th terminal is greater than or equal to the MCS level of the MAP for the first terminal, the base station recognizes that the first scheduling attempted the resource allocation to the k-th terminal. Hence, the base station determines whether the scheduling has been conducted by considering all of the terminals in step 619. For doing so, the base station compares the scheduling priority index k with the maximum number of the terminals N_{MAX}.

When the MCS level MCS_{MAP,k} of the MAP for the k-th terminal is lower than the MCS level of the MAP for the first terminal, the base station recognizes that the first scheduling did not attempt the resource allocation to the k-th terminal. Thus, the base station determines the temporary MCS_{MAP,frame} by considering the MCS level MCS_{MAP,k} of the MAP for the k-th terminal in step 607. For example, the base station determines the lower MCS level of MCS_{MAP,Frame} and MCS_{MAP,k} as the temporary MCS_{MAP,frame} based on Equation 1.

In step 609, the base station determines the number of data symbols of the corresponding frame based on the temporary MCS_{MAP,frame}. For example, based on the temporary MCS_{MAP,frame}, the base station calculates the number of the symbols to use for the MAP allocation. Next, the base station calculates the number of data symbols by removing the number of symbols to use for the MAP allocation from the total number of the symbols of the corresponding frame.

In step 611, the base station determines the number of available slots Slot_{data}_{_{—}}_{available} for allocating the data by considering the number of data symbols. For example, the base station checks the number of slots for allocating the data based on Equation 2.

In step 613, the base station examines whether a resource can be allocated to the k-th terminal based on the number of available slots for allocating the data. That is, the base station determines whether there is a slot that is allocable to the k-th terminal.

When the number of the available slots is greater than zero (Slot_{data}_{_{—}}_{available}>0), the base station recognizes that a resource is allocable to the k-th terminal. Next, the base station sets the temporary MCS_{MAP,frame} to the MCS level of the MAP for the frame.

Next, the base station allocates the service flow to the k-th terminal by allocating to the k-th terminal at least one of the available slots to allocate the data in step 617.

In step 619, the base station determines whether the scheduling has considered all of the terminals. For doing so, the base station compares the scheduling priority index k with the maximum number of terminals N_{MAX}.

When the scheduling priority index is less than the maximum number of the terminals, the base station recognizes that not all of the terminals have been considered. Hence, the base station updates the scheduling priority index in step 621. For example, the base station increases the scheduling priority index by one (k++).

Next, the base station determines whether the resource has been allocated to the k-th terminal through the first scheduling in step 603. Herein, the k-th terminal indicates the terminal of the scheduling priority index updated in step 621.

When the scheduling priority index is greater than or equal to the maximum number of the terminals in step 619, the base station recognizes that all of the terminals have been considered in the second scheduling. Accordingly, the base station ends this process.

Meanwhile, when the number of available slots is less than or equal to zero (Slot_{data}_{_{—}}_{available}≦0) in step 613, the base station recognizes that no resource is allocable to the k-th terminal. Thus, the base station determines whether to end the scheduling in step 623. For example, the base station determines whether to end the scheduling by comparing the MCS level of the MAP for the k-th terminal with the MCS level of the MAP for the frame.

When the MCS level of the MAP for the k-th terminal is lower than the MCS level of the MAP for the frame, the base station recognizes that the slot for the data allocation is allocable to the terminal with a higher MCS level than the MCS level of the MAP for the frame. Hence, the base station determines whether the scheduling has considered all of the terminals in step 619. For doing so, the base station compares the scheduling priority index k with the maximum number of the terminals N_{MAX}.

In contrast, when the MCS level of the MAP for the k-th terminal is greater than or equal the MCS level of the MAP for the frame, the base station recognizes that additional burst allocation is not feasible. Thus, the base station ends this process.

Now, a structure of the base station for scheduling based on the MCS level of the MAP for the terminals is explained.

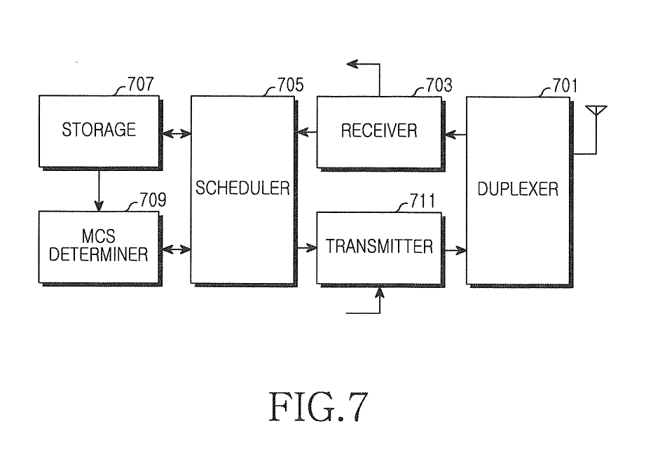

FIG. 7 is a step diagram of the base station according to an embodiment of the present invention.

The base station of FIG. 7 includes a duplexer 701, a receiver 703, a scheduler 705, a storage 707, an MCS determiner 709, and a transmitter 711.

The duplexer 701 sends a transmit signal output from the transmitter 711 over an antenna, and provides a receive signal from the antenna to the receiver 703 according to the duplexing scheme.

The receiver 703 demodulates a Radio Frequency (RF) signal fed from the duplexer 701 to a baseband signal. The receiver 703 can include an RF processing block, a demodulating block, a channel decoding block, and a message processing block. The RF processing block converts the RF signal output from the duplexer 701 to the baseband signal. The demodulating block includes a Fast Fourier Transform (FFT) operator for extracting data from subcarriers of the signal output from the RF processing block. The channel decoding block includes a demodulator, a deinterleaver, and a channel decoder. The message processing block extracts control information from the signal fed from the channel decoding block and provides the extracted control information to the scheduler 705.

The scheduler 705 allocates the resources to the terminals to service through the scheduling. During the scheduling, the scheduler 705 considers the MCS level of the MAP for at least one terminal provided from the MCS determiner 709. For example, the scheduler 705 carries out the scheduling by considering the MCS level of the MAP for the terminal as shown in FIG. 2, FIG. 3, or FIG. 4.

The storage 707 stores information for the scheduling of the scheduler 705. The storage 707 contains a threshold table for the MCS determiner 709 to determine the MCS level of the MAP for the terminal. For example, the threshold table is constituted as shown in Table 1.

The MCS determiner 709 determines the MCS level of the MAP for the terminals by considering the channel state information of at least one terminal to be serviced by the base station. For example, the MCS determiner 709 determines the MCS level of the MAP for the terminal as shown in FIG. 1.

The transmitter 711 encodes and converts data and a control message for transmission to an RF signal and outputs the RF signal to the duplexer 701. The transmitter 711 can include a message generating block, a channel coding block, a modulating block, and an RF processing block. The message generating block generates a resource allocation message including the resource allocation information based on the scheduling result of the scheduler 705. The channel coding block includes a modulator, an interleaver, a channel encoder, and so forth. The modulating block includes an Inverse FFT (IFFT) operator for mapping the signal output from the channel coding block to subcarriers. The RF processing block converts the baseband signal output from the modulating block to an RF signal and outputs the RF signal to the duplexer 701.

As set forth above, the wireless communication system adaptively determines the MCS level of the resource allocation information by considering the channel state information of at least one terminal allocated the resource. Therefore, stable performance can be ensured for the frame allocated to the terminal traveling near the edge of the cell by allocating the low MCS level of the resource allocation information, and the data rate of the traffic can be raised by allocating the high MCS level of the resource allocation information to the frame allocated to the terminal traveling around the base station.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A resource scheduling method in a wireless communication system, the resource scheduling method comprising:
determining a Modulation and Coding Scheme (MCS) level of resource allocation information of at least one terminal;
determining a temporary MCS level for resource allocation information of a frame by considering the MCS level for resource allocation information of a k-th terminal of the at least one terminal;
determining a resource amount for allocating data by considering the temporary MCS level;
determining whether a resource is allocable to the k-th terminal by considering the resource amount for the data allocation; and
when the resource is allocable to the k-th terminal, determining the MCS level of the resource allocation information of the frame by considering the MCS level of the resource allocation information of the k-th terminal,
wherein k denotes an index of a scheduling priority.

2. The resource scheduling method of claim 1, wherein determining the MCS level comprises:
determining channel state information for the at least one terminal; and
determining the MCS level of the resource allocation information of each terminal by comparing the channel state information for each terminal with at least one threshold.

3. The resource scheduling method of claim 1, wherein determining a temporary MCS level comprises:
setting the temporary MCS level to the lower of an MCS level for the resource allocation information of the k-th terminal and an MCS level of resource allocation information of a frame determined in a previous scheduling.

4. The resource scheduling method of claim 3, wherein the MCS level of the resource allocation information of the frame determined in the previous scheduling sets an initial value to the highest MCS level of two or more MCS levels available to a base station.

5. The resource scheduling method of claim 1, wherein determining whether a resource is allocable to the k-th terminal comprises:
determining a number of available slots for the data allocation by considering the resource amount for the data allocation; and
determining whether the resource is allocable to the k-th terminal by considering the number of available slots.

6. The resource scheduling method of claim 1, wherein determining the MCS level of the resource allocation information of the frame comprises:
when the resource is allocable to the k-th terminal, determining the lower MCS level between the MCS level for the resource allocation information of the k-th terminal and the MCS level of resource allocation information of the frame determined in a previous scheduling to be the MCS level for the resource allocation information of the frame.

7. The resource scheduling method of claim 6, wherein the MCS level of the resource allocation information of the frame determined in the previous scheduling sets an initial value to the highest MCS level of two or more MCS levels available to a base station.

8. The resource scheduling method of claim 1, further comprising:
after determining the MCS level for the resource allocation information of the frame, determining whether the scheduling has been performed for every terminal to service,
wherein, when every terminal to service has not been considered, the temporary MCS level is determined and the temporary MCS level for the resource allocation information of the frame is determined by considering an MCS level of the resource allocation information of a terminal of a next scheduling priority (k+1).

9. A resource scheduling apparatus in a wireless communication system, the resource scheduling apparatus comprising:
a transmitter configured to transmit a signal;
a receiver configured to receive a signal;
a Modulation and Coding Scheme (MCS) determiner configured to determine an MCS level of resource allocation information of a terminal; and
a scheduler configured to determine a resource amount for allocating data by considering a temporary MCS level determined by considering an MCS level for resource allocation information of a k-th terminal of at least one terminal, and determine the MCS level of the resource allocation information of the frame by considering the MCS level of the resource allocation information of the k-th terminal when the resource is allocable to the k-th terminal according to the resource amount for the data allocation,
wherein k denotes an index of a scheduling priority.

10. The resource scheduling apparatus of claim 9, wherein the MCS determiner is further configured to determine the MCS level of the resource allocation information of a terminal by comparing channel state information of the at least one terminal with at least one threshold.

11. The resource scheduling apparatus of claim 9, wherein the scheduler is further configured to set a lower MCS level of the MCS level for the resource allocation information of the k-th terminal and an MCS level of resource allocation information of a frame determined in previous scheduling as the temporary MCS level.

12. The resource scheduling apparatus of claim 11, wherein the MCS level of the resource allocation information of the frame determined in the previous scheduling sets an initial value to the highest MCS level of two or more MCS levels available to a base station.

13. The resource scheduling apparatus of claim 9, wherein the scheduler is further configured to determine a number of available slots for the data allocation by considering the resource amount for the data allocation, and determine whether the resource is allocable to the k-th terminal by considering the number of available slots.

14. The resource scheduling apparatus of claim 9, wherein, when the resource is allocable to the k-th terminal, the scheduler is further configured to determine the lower MCS level of the MCS level for the resource allocation information of the k-th terminal and the MCS level of the resource allocation information of the frame determined in a previous scheduling to be the MCS level for the resource allocation information of the frame.

15. The resource scheduling apparatus of claim 14, wherein the MCS level of the resource allocation information of the frame determined in the previous scheduling sets an initial value to the highest MCS level of two or more MCS levels available to a base station.

16. The resource scheduling apparatus of claim 9, wherein, after determining the MCS level for the resource allocation information of the frame, the scheduler is further configured to determine whether the scheduling has been performed for every terminal in the at least one terminal to service, and when every terminal to service has not been considered, re-determine the temporary MCS level for the resource allocation information of the frame by considering an MCS level of the resource allocation information of the terminal of a next scheduling priority (k+1).

17. A wireless communication system for scheduling resources, the wireless communication system comprising:
a base station configured to receive channel state information from at least one terminal, determine a Modulation and Coding Scheme (MCS) level for resource allocation information of the one or more terminal by considering corresponding channel state information, determine a resource amount for allocating data by considering a temporary MCS level determined based on an MCS level for resource allocation information of a k-th terminal of the one or more terminal, and determine the MCS level for the resource allocation information of the frame by considering the MCS level of the resource allocation information of the k-th terminal when the resource is allocable to the k-th terminal according to the resource amount for the data allocation,
wherein k denotes an index of a scheduling priority.

18. The wireless communication system of claim 17, wherein, when the resource is allocable to the k-th terminal, the base station is further configured to determine the lower MCS level of the MCS level for the resource allocation information of the k-th terminal and an MCS level of resource allocation information of a frame determined in a previous scheduling to be the MCS level for the resource allocation information of the frame.

19. The wireless communication system of claim 18, wherein the MCS level of the resource allocation information of the frame determined in the previous scheduling sets an initial value to the highest MCS level of two or more MCS levels available to the base station.

20. The wireless communication system of claim 17, wherein, after determining the MCS level for the resource allocation information of the frame, the base station is further configured to determine whether the scheduling has been performed for every terminal of the at least one terminal to service, and
when every terminal to service has not been considered, re-determine the temporary MCS level for the resource allocation information of the frame by considering an MCS level of the resource allocation information of a terminal of a next scheduling priority (k+1).
